(19) United States
(12) Patent Application Publication
(10) Pub. No.: US 2015/0339005 A1
(43) Pub. Date: Nov. 26, 2015

(54) METHODS FOR HANDLING APPLICATIONS RUNNING IN THE EXTEND MODE AND TABLET COMPUTERS USING THE SAME

(71) Applicant: Wistron Corp., New Taipei City (TW)

(72) Inventor: Daqiang LI, New Taipei City (TW)

(21) Appl. No.: 14/562,622

(22) Filed: Dec. 5, 2014

(30) Foreign Application Priority Data
May 23, 2014 (CN) 201410222032.6

(51) Int. Cl. G06F 3/0482; G06F 3/0484

(52) U.S. Cl. CPC G06F 3/0482; G06F 3/04842

(57) ABSTRACT

The invention introduces a method for handling applications running in an extend mode, executed by a processing unit of a tablet computer, which contains at least the following steps. After it is detected that an external display device is connected to the tablet computer, a mode selection menu is provided on a display unit of the tablet computer. After it is detected that a user has selected an extend mode of the mode selection menu, a dialog is provided on the display unit to help the user to configure a screen of each application to be output to the display unit or the external display device. A confguration result of the dialog by the user is stored to a database.

### CROSS REFERENCE TO RELATED APPLICATIONS

This Application claims priority of China Patent Application No. 201410222032.6, filed on May 23, 2014, the entirety of which is incorporated by reference herein.

### BACKGROUND

1. Technical Field

The present invention relates to an application operation, and in particular to methods for handling applications running in the extend mode and tablet computers using the same.

2. Description of the Related Art

When a conventional tablet computer running the Android® OS (Operating System) is connected to a display device (also called an external display device) via a signal wire, the external display device may duplicate and enlarge a screen displayed on a built-in display device (also called a main display device), and show a simple dialog box for a data input. However, a typical Android® tablet computer does not provide an extend mode, prohibiting the main display device and the external display device from showing two application screens simultaneously. Thus, it is desirable to have methods for handling applications running in the extend mode and tablet computers using the same to realize application screen running in the Android® OS being selectively displayed on either the main display device or the external display device.

### BRIEF SUMMARY

An embodiment of the invention introduces a method for handling applications running in an extend mode, executed by a processing unit of a tablet computer, which contains at least the following steps. After it is detected that an external display device is connected to the tablet computer, a mode selection menu is provided on a display unit of the tablet computer. After it is detected that a user has selected an extend mode of the mode selection menu, a dialog is provided on the display unit to help the user to configure a screen of each application to be output to the display unit or the external display device. A configuration result of the dialog by the user is stored to a database.

An embodiment of the invention introduces a tablet computer containing at least a display unit, a storage device and a processing unit. The processing unit, after detecting that an external display device is connected to the tablet computer, provides a mode selection menu on the display unit; after detecting that a user has selected an extend mode of the mode selection menu, provides a dialog on the display unit to help the user to configure a screen of each application to be output to the display unit or the external display device; and stores a configuration result of the dialog by the user to a database.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 illustrates the system architecture of dual monitors according to an embodiment of the invention;

FIG. 2 is the system architecture of a tablet computer according to an embodiment of the invention;

FIG. 3 illustrates the system architecture of the Android® OS according to an embodiment of the invention;

FIG. 4 is a flowchart illustrating a method for dispatching application screen images to display devices, performed by a processing unit of a tablet computer when relevant software codes and/or instructions are loaded and executed, according to an embodiment of the invention;

FIG. 5A is a schematic diagram of a screen on a display unit according to an embodiment of the invention;

FIG. 5B is a schematic diagram of a screen on a display unit according to an embodiment of the invention;

FIG. 6 is a class diagram of a display manager according to an embodiment of the invention;

FIG. 7 is an object diagram for application screens according to an embodiment of the invention;

FIG. 8 is a flowchart illustrating a method for configuring a screen output, performed by a processing unit of a tablet computer when relevant software codes and/or instructions are loaded and executed, according to an embodiment of the invention;

FIG. 9 is a class diagram of a window manager according to an embodiment of the invention;

FIG. 10A is a browser screen 1010 displayed on the external display device 130 according to an embodiment of the invention; and

FIG. 10B is a calculator screen 1020 displayed on the display unit 220 according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

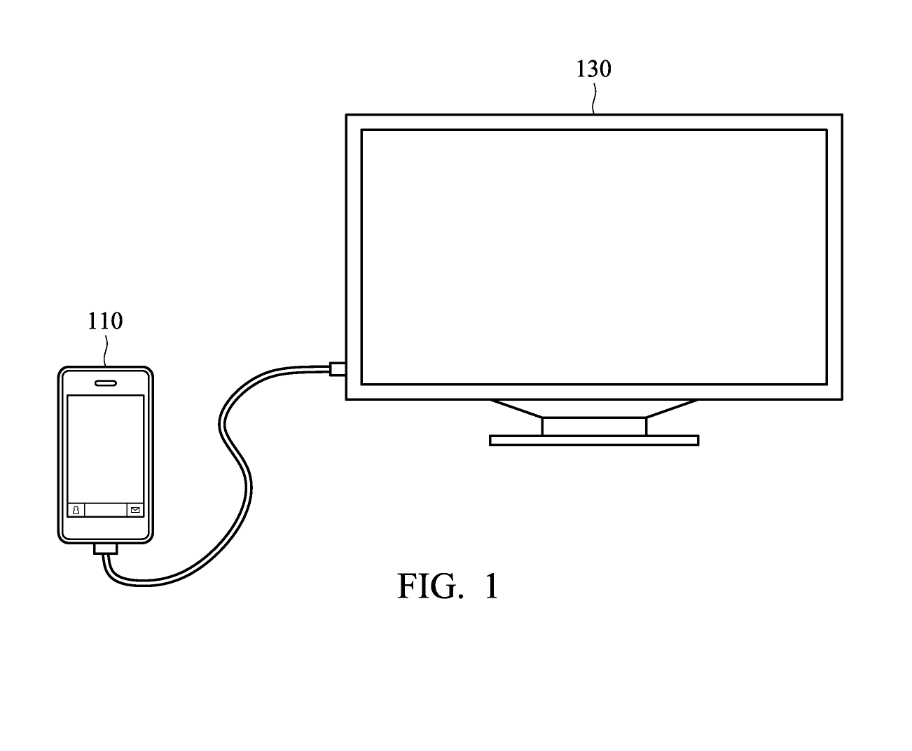

Embodiments of the invention are operated in the system architecture of dual monitors. FIG. 1 illustrates the system architecture of dual monitors according to an embodiment of the invention, containing a tablet computer 110 and a display device 130 (which may be referred to as an external display device interchangeably in the following paragraphs). The display device 130 includes a display panel, such as a TFT-LCD (Thin film transistor liquid-crystal display) panel, an OLED (Organic Light-Emitting Diode) panel, or others, being controlled by the tablet computer 110 to display input letters, alphanumeric characters and symbols, dragged paths, drawings, or screens provided by an application for the user to view. The display device 130 may use a communications interface to connect to the tablet computer 110, such as the HDMI (High Definition Multimedia Interface). HDMI is a digital audio/video interface for transferring uncompressed video data and compressed or uncompressed digital audio data. Those skilled in the art may realize the invention in the system architecture including more than two external display devices without departing from the spirit of the invention, and the invention should not be limited thereto.

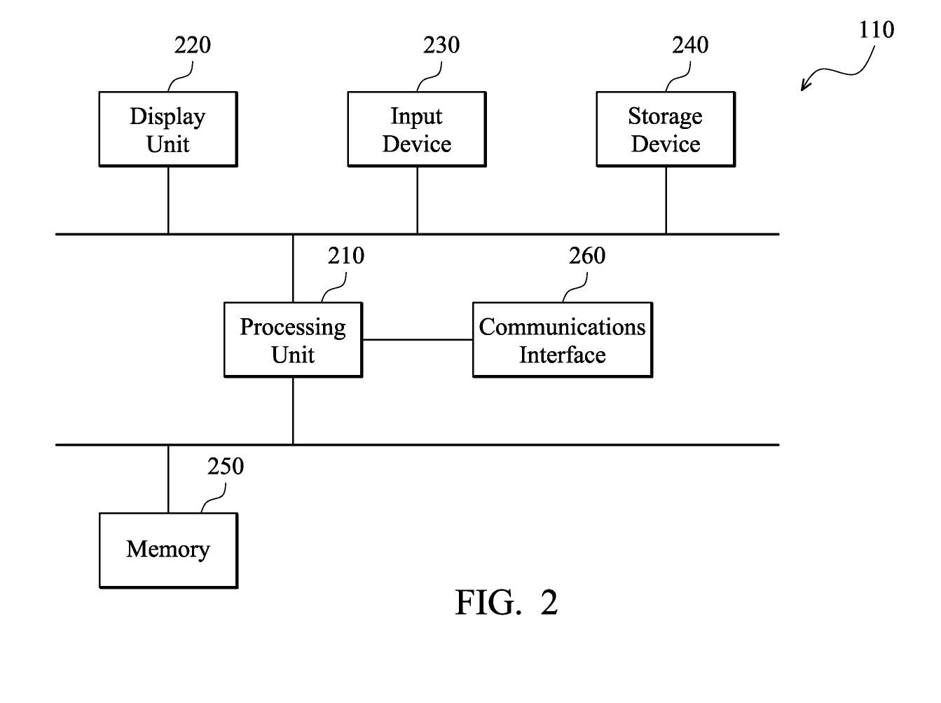

FIG. 2 is the system architecture of a tablet computer according to an embodiment of the invention, containing at least a processing unit 210. The processing unit 210 can be implemented in numerous ways, such as with dedicated hardware, or with general-purpose hardware (e.g., a single processor, multiple processors or graphics processing units capable of parallel computations, or others) that is programmed using microcode or software instructions to perform the functions recited herein. The system architecture further includes a memory 250 for storing necessary data in execution, such as variables, data tables, or others, and a storage unit 240 for storing a wide range of electronic files, such as Web pages, documents, video files, audio files, or others. A communications interface 260 is included in the system architecture and the processing unit 210 can thereby communicate with the display device 130. The communications interface 260 may be an HDMI. An input device 230 may include a touch panel to help a user to make a gesture to control executed applications. The gestures include, but are not limited to, a single-click, a double-click, a single-finger dragging, and a multiple finger dragging. A display unit 220 (may be referred to as a main display device interchangeably in the following paragraphs) may include a display panel, such as a TFT-LCD (Thin film transistor liquid-crystal display) panel, an OLED (Organic Light-Emitting Diode) panel, or others, to display input letters, alphanumeric characters and symbols, dragged paths, drawings, or screens provided by an application for the user to view.

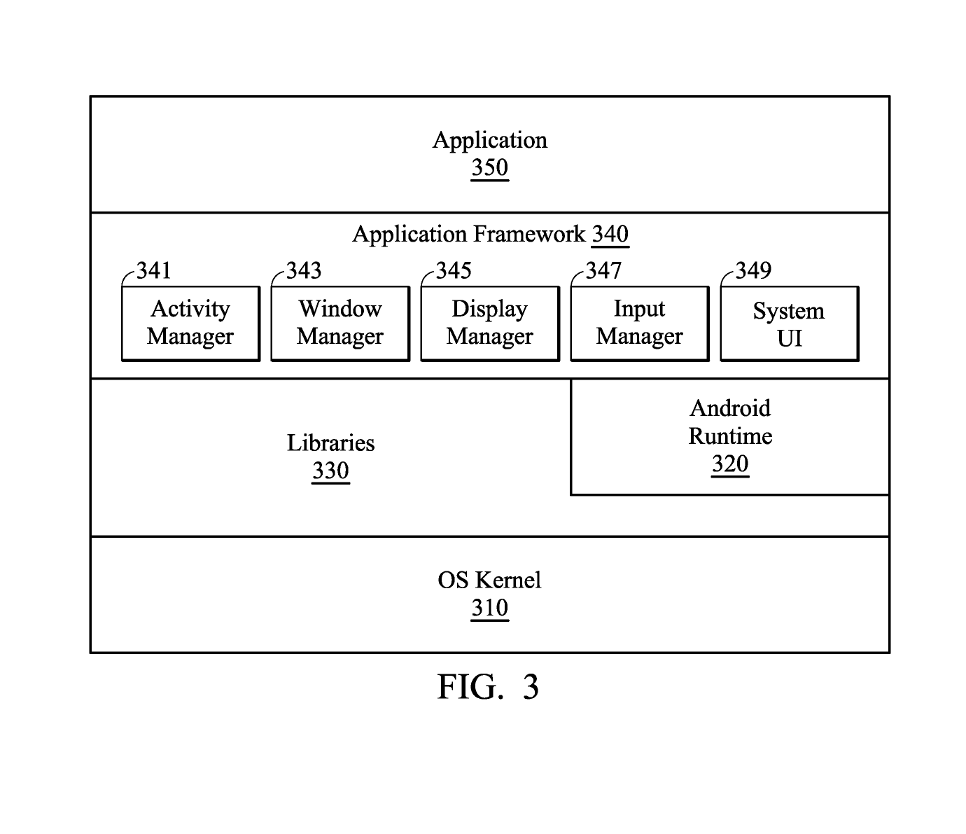

FIG. 3 illustrates the system architecture of the Android® OS according to an embodiment of the invention. The OS kernel 310, at the bottom layer, provides basic system functionality such as process management, memory management, and device management like camera, keypad, display, etc. Also, the OS kernel 310 handles networking and a vast array of device drivers, which take the applications 350 out of interfacing to peripheral hardware. On top of the OS kernel 310 is a set of libraries 330 including open-source Web browser engine WebKit, and SQLite database which is a useful repository for storage and sharing of application data. The libraries 330 also provide functionality such as playback and recording of audio and video, Internet security, etc. The Android runtime 320 provides a key component called Dalvik VM (Virtual Machine) which is a kind of Java Virtual Machine specially designed and optimized for Android system. The Dalvik VM makes use of Linux core features like memory management and multi-threading, which is intrinsic to the Java language. The Dalvik VM enables every Android application to run in its own process, with its own instance of the Dalvik virtual machine. The Android runtime 320 also provides a set of core libraries which enable Android application developers to write Android applications by using standard Java programming language. The application framework 340 provides many higher-level services to applications 350 in the form of Java classes, including the activity manager 341, the window manager 343, the display manager 345, the input manager 347, the system UI module 349, etc. Application developers are allowed to make use of these services in their applications 350.

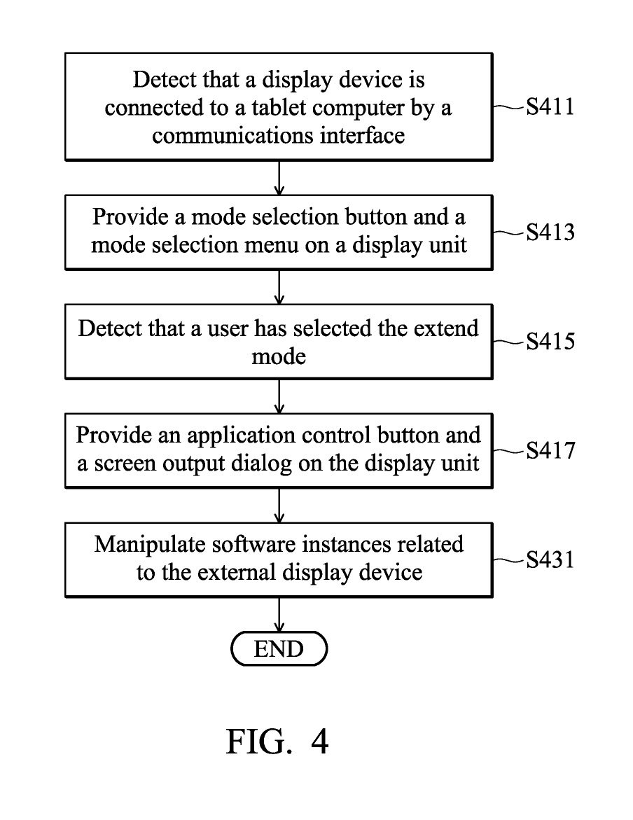

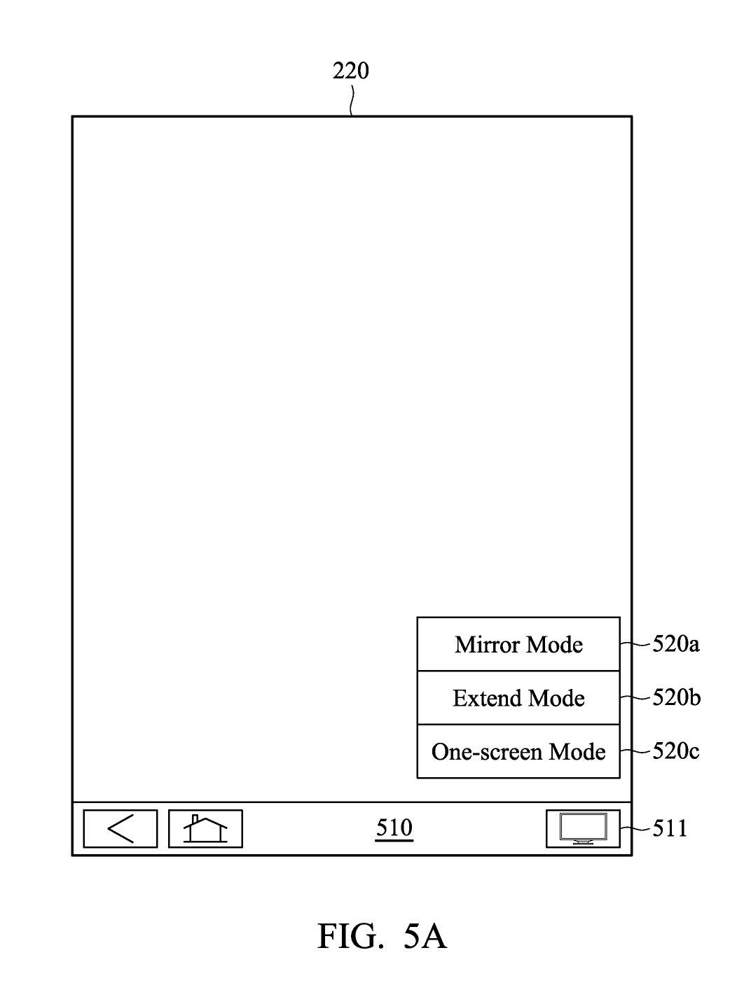

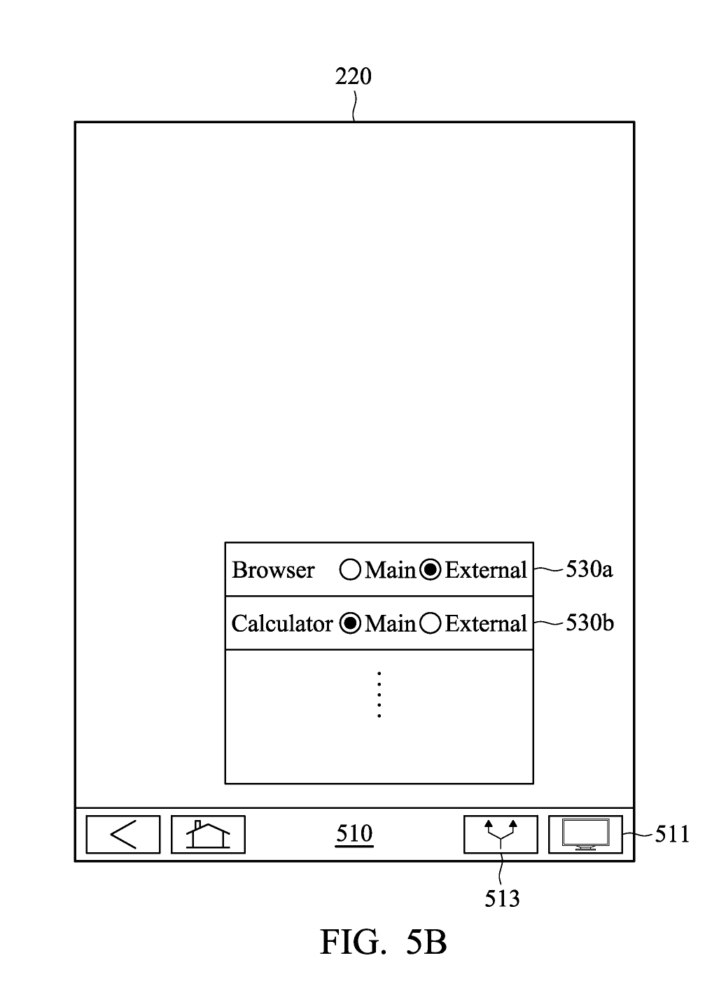

FIG. 4 is a flowchart illustrating a method for dispatching application screen images to display devices, performed by the processing unit 210 of the tablet computer 110 when relevant software codes and/or instructions are loaded and executed, according to an embodiment of the invention. First, after detecting that the display device 130 is connected to the tablet computer 110 by the communications interface 260 (step S411), the processing unit 210 provides a mode selection button and a mode selection menu on the display unit 220 (step S413). In step S411, a listening event may be registered to the system UI module 349. It is detected that the display device 130 is connected to the tablet computer 110 by the communications interface 260 when the listening event is triggered. FIG. 5A is a schematic diagram of a screen on the display unit 220 according to an embodiment of the invention. In step S413, after the listening event is triggered, relevant program codes are executed to provide a mode selection button 511 in a navigation bar 510 on the display unit 220. The navigation bar 510 further includes two default buttons, one is used to switch to the screen of the last executed application, and the other is used to switch to the home screen. When the mode selection button 511 is clicked, a mode selection menu containing items 520a to 520c is displayed on the display unit 220. When detecting that the item “mirror mode” 520a is clicked, the processing unit 210 knows that the user expects that both the display unit 220 and the external display device 130 will display the same screen. When detecting that the item “extend mode” 520b is clicked, the processing unit 210 knows that the user expects that the display unit 220 and the external display device 130 will display different respective application screens. When detecting that the item “one-screen mode” 520c is clicked, the processing unit 210 knows that the user expects that only the external display device 130 is used to display a screen. Subsequently, after it is detected that a user has selected the extend mode (step S415), an application control button and a screen output dialog are provided on the display unit 220 (step S417). FIG. 5B is a schematic diagram of a screen on the display unit 220 according to an embodiment of the invention. In step S417, after the item “extend mode” 520b is clicked, relevant program codes are executed to provide an application control button 513 in the navigation bar 510 on the display unit 220. When the application control button 513 is clicked, a dialog containing setting items 530a to 530b is displayed on the display unit 220. Each setting item helps a user to configure a specified application screen to be output to the display unit 220 or the external display device 130. When the application control button 513 is clicked again, the dialog is hidden, and the configuration results are stored in a database of the storage device 240, such as the SQLite. For example, the setting item 530a shows that a user expects to output the browser screen to the external display device 130 and the setting item 530b shows that a user expects to output the calculator screen to the display unit 220.

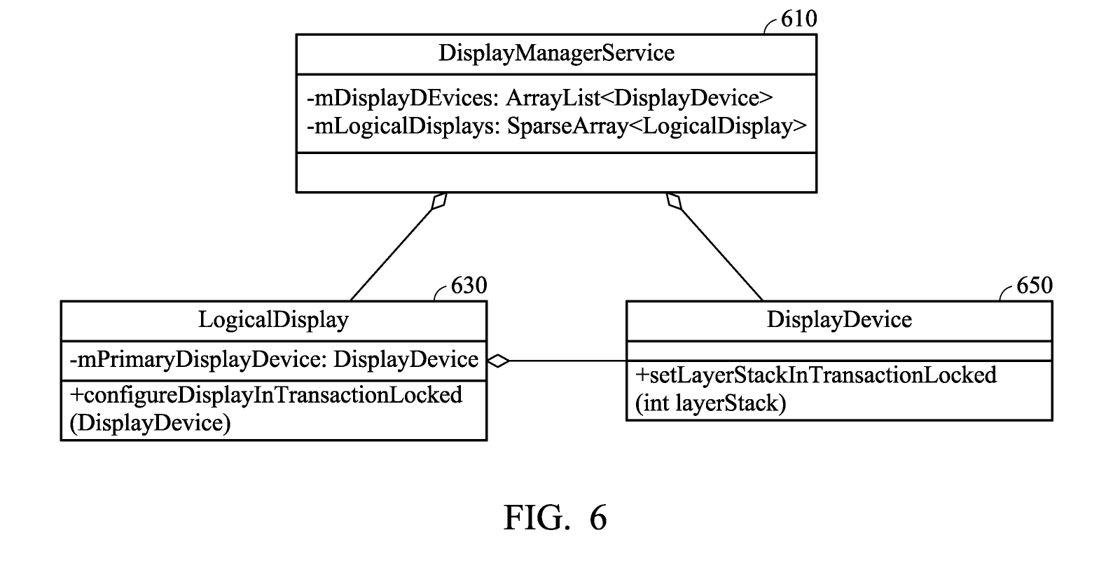

The processing unit 210 subsequently manipulates software instances related to the external display device 130 to be consistent with the resolutions between the external display device 130 and the display unit 220 and make the external display device 130 and the display unit 220 display screens independently (step S431). FIG. 6 is a class diagram of a display manager according to an embodiment of the invention. When the external display device 130 is connected to the tablet computer 110, a display device instance “DisplayDevice” 650 associated with the external display device 130 is created in the display manager 345, and the display device instance 650 is added to a display device list “mDisplayDevice” of a display manager service “DisplayManagerService” 610. In addition, a logical display instance “LogicalDisplay” 630 associated with the external display device 130 is created in the display manager 345, and the logical display instance 630 is added to a logical display list “mLogicalDisplay” of the display manager service 610. Those skilled in the art will realize that the display device list further contains a display device instance 650 associated with the display unit 220, and the logical display list further contains a logical display instance 630 associated with the display unit 220. Specifically, in step S431, a method “configureDisplayInTransactionLocked” of the logical display instance 630 is used to modify a display scope, a screen orientation and a layer stack “layerStack” value of a surface flinger “surfaceflinger”. The logical display instance 630 of the external display device 130 is initialized with a layer stack value that is different from that of the display unit 220. For example, the layer stack value for the display unit 220 is zero while the layer stack value for the external display device 130 is one. The difference of the layer stack values between the external display device 130 and the display unit 220 means that the external display device 130 and the display unit 220 belong to different layer stacks, thereby enabling the external display device 130 and the display unit 220 to render different screens of the applications 350. Moreover, a method “setDisplayLaerStack(IBinder displayToken, int layerStack)” of a surface associated with each application is used to place a screen to one of the layer stacks to display the application screen on the display unit 220 or the external display device 130.

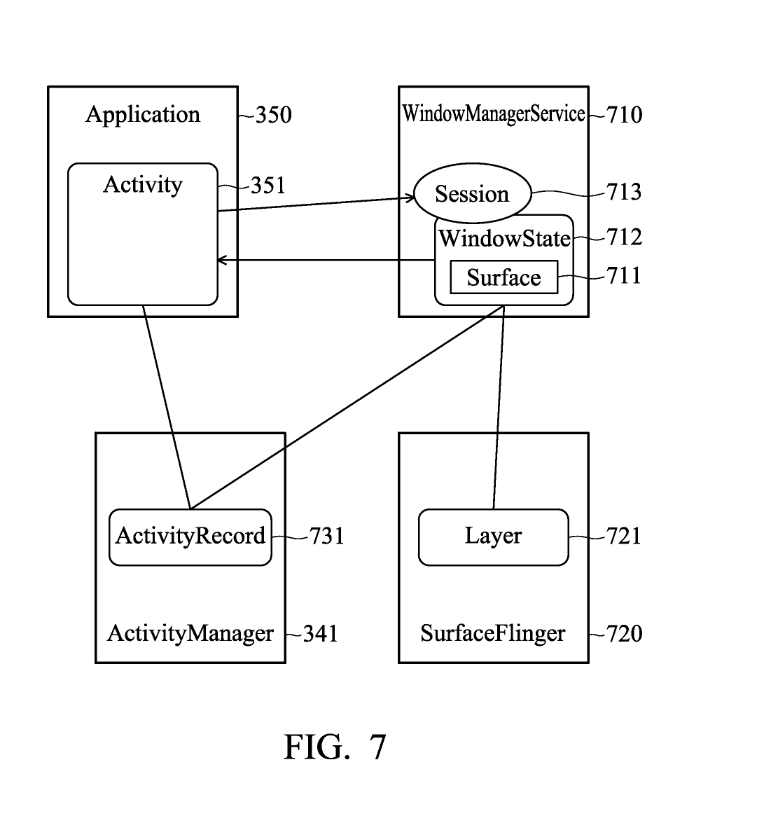

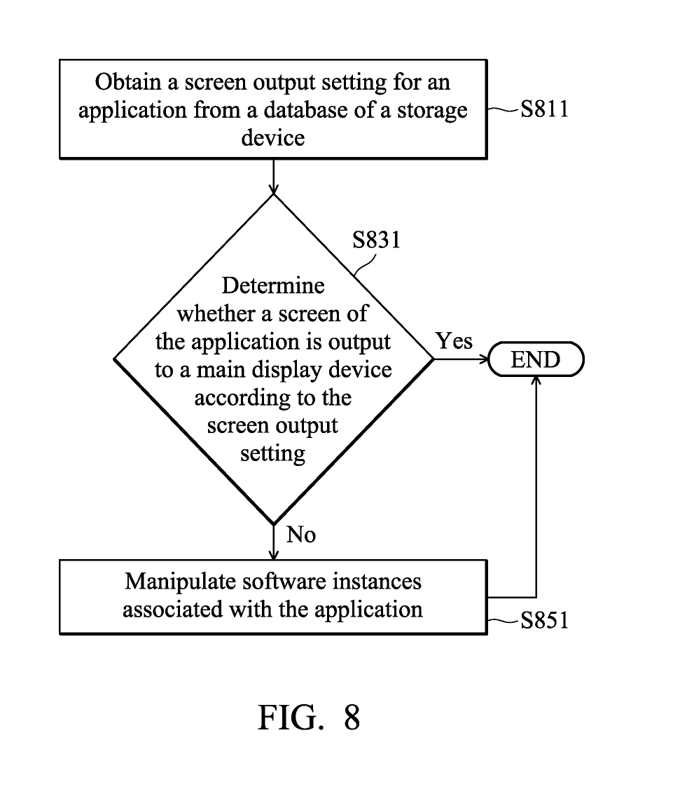

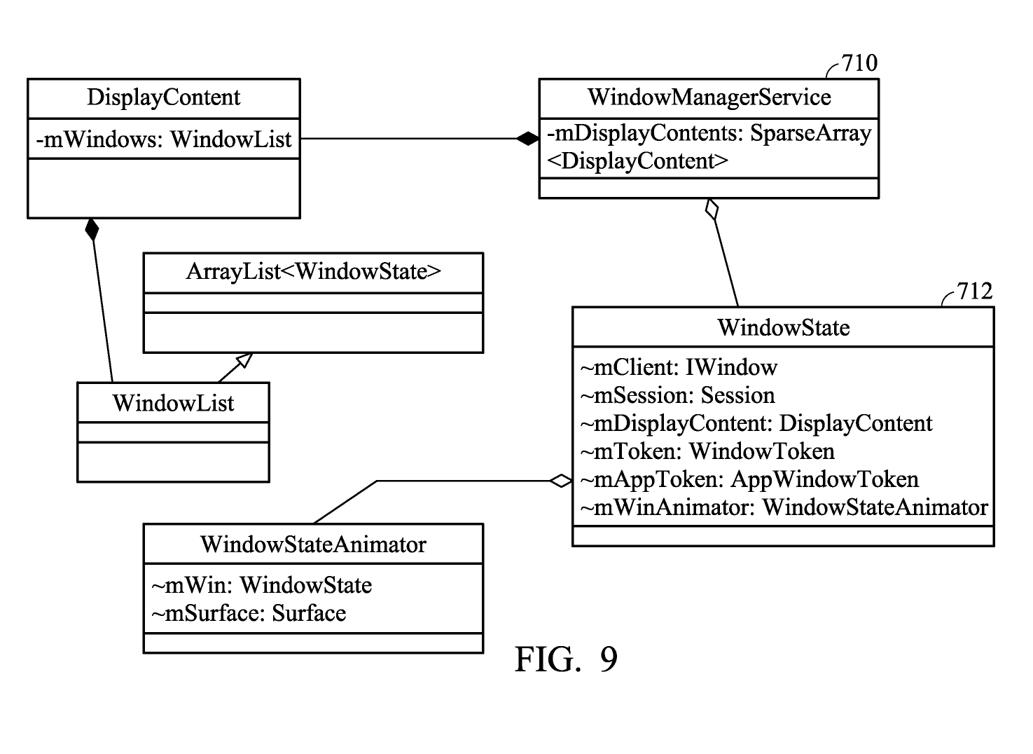

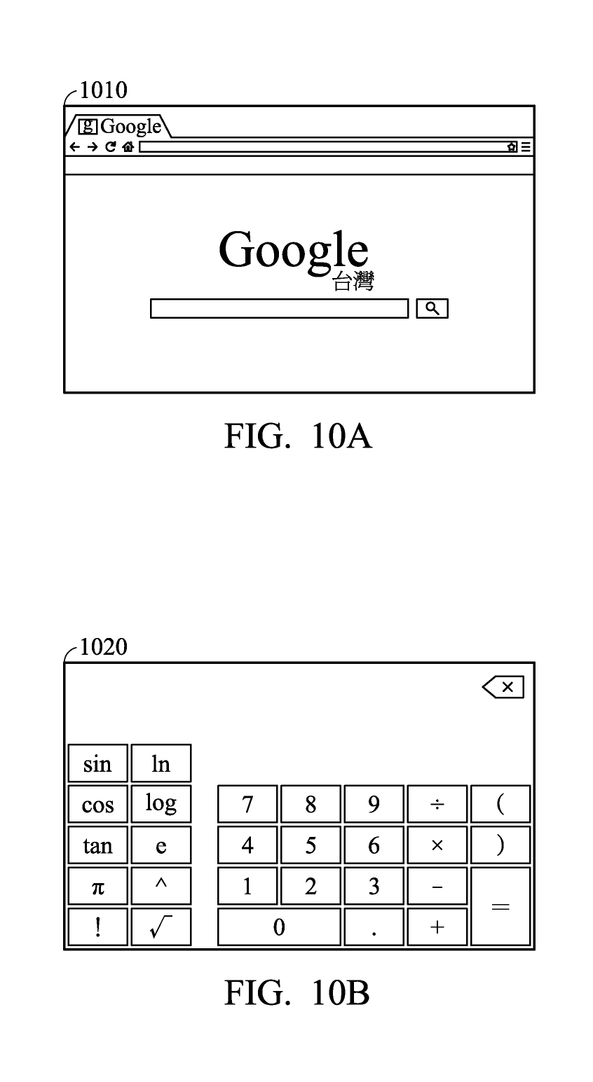

FIG. 7 is an object diagram for application screens according to an embodiment of the invention. The first time a user launches an application 350, an activity manager 341 creates a process for the application 350, i.e. an activity thread instance “ActivityThread”, to handle the execution of a main program, arrange and perform activities according to requests by clients, and broadcast operating methods. The application 350 uses a method “createBaseContextForActivity” of the activity thread instance to produce a context, thereby to obtain a window manager “WindowManager” instance 343. Subsequently, the application 350 uses a method “addView” of the window manager instance 343 to add a screen corresponding to an activity 351 to a screen list related to the display unit 220 or the external display device 130, which is included in a window manager service “WindowManagerService” 710, according to a display identity “displayId”. A layer stack value of a surface 711 generated by the window manager service 710 is set to the layer stack value associated with the display unit or the external display device 130. The surface flinger “SurfaceFlinger” 720 contains a layer 721 associated with the application 350. During a screen refresh, the layer stack value of the layer 721 is compared with the layer stack value of the display device instance 650 associated with the external display device 130. If they are the same, then the layer 721 is added to the layer list owned by the external display device 130 to combine and be sent to a frame buffer of the external display device 130. If the layer stack value of the layer 721 is the same as that of the display device 650 associated with the display unit 220, then the layer 721 is added to the layer list owned by the display unit 220. FIG. 8 is a flowchart illustrating a method for configuring a screen output, performed by the processing unit 210 of the tablet computer 110 when relevant software codes and/or instructions are loaded and executed, according to an embodiment of the invention. First, a screen output setting for an application is obtained from a database of the storage device 240 (step S811). Technical details for setting screen output may be referred to the description of FIG. 5B and step S417. Then, it is determined whether the screen of the application is output to the main display device according to the screen output setting (step S831). If not, software instances associated with the application are manipulated to output the screen to the external display device 130 (step S851). FIG. 9 is a class diagram of a window manager according to an embodiment of the invention. In step S851, specifically, a method “performLaunchActivity” of an activity thread instance is used to generate a context associated with the external display device 130 and a window manager implement “WindowManagerImpl”, where the window manager implement overwrites the original window manager. A method “handleResumeActivity” of the activity thread instance to generate a new window manager instance, and a method “addView” of the window manager instance is used to generate a screen corresponding to the application 350. A method “addToDisplay” of a session instance 713 is used to add the screen associated with the application 350 to a screen list “mDisplayContents” of the window manager service “WindowManagerService” 710. A method “addWindow” of the window manager service 710 is used to produce a surface containing the layer stack value of the external display device 130 according to its display identity, thereby enabling the surface to be added to the layer list of the external display device 130. FIG. 10A is a browser screen 1010 displayed on the external display device 130 according to an embodiment of the invention. FIG. 10B is a calculator screen 1020 displayed on the display unit 220 according to an embodiment of the invention.

When a screen of the application 350 displayed on the display unit 220 of the tablet computer 110, a user may operate the application 350 through a touch gesture or a mouse. When the screen of the application 350 is displayed on the external display device 130, a user can only operate the application 350 through the mouse. A cursor may be moved between the external display device 130 and the display unit 220. When it is detected that the cursor has moved beyond an edge of the display unit 220 and into a scope of the external display device 130, a display identity “displayId” of a input dispatcher “InputDispatcher” is modified to enable a cursor event to be dispatched to the application 350 displayed on the external display device 130. When it is detected that the cursor has moved in the display unit 220, the display identity of the input dispatcher maintains. The external display device 130 and the display unit 220 have different window states “WindowState” 712, and each window state 712 maps to an input window handle “InputWindowHandle”. The input dispatcher determines whether the display identity thereof is the same as that of the input window handle. If they are the same, then the input dispatcher and the input window handle associate with the same display device, and an event type and coordinate values are dispatched to the input window handle. In order to display the cursor in the external display device 130, a layer stack value of a pointer controller “PointerController” is modified with the layer stack value of the external display device 130, resulting in the layer associated with the cursor being added to the layer list of the external display device 130. Subsequently, a focus of the window manager service is updated with a window state “WindowState” 712 of the application 350 to be moved, and all activity records “ActivityRecord” 731 of a task stack of an activity manager “ActivityManager” instance 341 related to the application 350 to be moved are placed on the top of an activity record list.

Although the embodiment has been described as having specific elements in FIG. 2, it should be noted that additional elements may be included to achieve better performance without departing from the spirit of the invention. While the process flows described in FIGS. 4 and 8 each include a number of operations that appear to occur in a specific order, it should be apparent that these processes can include more or fewer operations, which can be executed in series or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for handling applications running in an extend mode, performed by a processing unit of a tablet computer, comprising:
detecting that an external display device is connected to the tablet computer;
providing a mode selection menu on a display unit of the tablet computer;
detecting that an extend mode of the mode selection menu has been selected;
providing a dialog on the display unit to configure a screen of each application to be output to the display unit or the external display device; and
storing a configuration result of the dialog to a database.

2. The method of claim 1, wherein the step for providing a mode selection menu on a display unit of the tablet computer further comprises:
providing a mode selection button in a navigation bar on the display unit; and
when detecting that the mode selection button is clicked, providing the mode selection menu on the display unit.

3. The method of claim 2, wherein the step for providing a dialog on the display unit further comprises:
providing an application control button in the navigation bar on the display unit;
detecting that the application control button is clicked; and
providing the dialog on the display unit.

4. The method of claim 3, further comprising:
manipulating an instance of an application framework, which is associated with the external display device, thereby enabling the external display device and the display unit to be displayed independently.

5. The method of claim 4, wherein the step for manipulating an instance of an application framework, which is associated with the external display device, further comprises:
initializing a first logic display instance of the external display device with a first layer stack value, wherein the display unit is associated with a second layer stack value.

6. The method of claim 5, further comprising:
when it is the first time an application is launched, obtaining a screen output setting of the application from the database;
determining whether a screen of the application is output to the external display device according to the screen output setting; and
when the screen of the application is set to output to the external display device, manipulating an instance of the application framework, which is associated with the application, to output the screen to the external display device.

7. The method of claim 6, wherein the step for manipulating an instance of the application framework, which is associated with the application, further comprises:
manipulating an activity thread instance of the application to generate a window manager instance;
using a first method of the window manager instance to generate the screen of the application;
using a second method of a session instance to add the screen to a screen list of a window manager service; and
using a third method of the window manager service to produce a surface containing the first layer stack value, thereby enabling the surface to be added to a layer list of the external display device.

8. The method of claim 7, further comprising:
when detecting that a cursor has moved beyond an edge of the display unit and into a scope of the external display device, modifying a display identity of a input dispatcher with the first layer stack value to enable a cursor event to be dispatched to the application;
modifying a layer stack value of a pointer controller with the first layer stack value;
updating a focus of the window manger service with the screen of the application; and
moving all activity records of a task stack of an activity manager instance related to the application on the top of an activity record list.

9. A tablet computer, comprising:
a display unit;
a storage device; and
a processing unit, detecting that an external display device is connected to the tablet computer; providing a mode selection menu on the display unit;
detecting that an extend mode of the mode selection menu has been selected; providing a dialog on the display unit to configure a screen of each application to be output to the display unit or the external display device; and storing a configuration result of the dialog to a database.

10. The tablet computer of claim 9, wherein the processing unit provides a mode selection button in a navigation bar on the display unit; and when detecting that the mode selection button is clicked, provides the mode selection menu on the display unit.

11. The tablet computer of claim 10, wherein the processing unit provides an application control button in the navigation bar on the display unit; detecting that the application control button is clicked; and provides the dialog on the display unit.

12. The tablet computer of claim 11, wherein the processing unit manipulates an instance of an application framework, which is associated with the external display device, thereby enabling the external display device and the display unit to be displayed independently.

13. The tablet computer of claim 12, wherein the processing unit initializes a first logic display instance of the external display device with a first layer stack value, wherein the display unit is associated with a second layer stack value.

14. The tablet computer of claim 13, wherein the processing unit, when it is the first time an application is launched, obtains a screen output setting of the application from the database; determines whether a screen of the application is output to the external display device according to the screen output setting; and when the screen of the application is set to output to the external display device, manipulates an instance of the application framework, which is associated with the application, to output the screen to the external display device.

15. The tablet computer of claim 14, wherein the processing unit manipulates an activity thread instance of the application to generate a window manager instance; uses a first method of the window manager instance to generate the screen of the application; uses a second method of a session instance to add the screen to a screen list of a window manager service; and uses a third method of the window manager service to produce a surface containing the first layer stack value, thereby enabling the surface to be added to a layer list of the external display device.

16. The tablet computer of claim 15, wherein the processing unit, when detecting that a cursor has moved beyond an edge of the display unit and into a scope of the external display device, modifies a display identity of a input dispatcher with the first layer stack value to enable a cursor event to be dispatched to the application; modifies a layer stack value of a pointer controller with the first layer stack value; updates a focus of the window manger service with the screen of the application; and moves all activity records of a task stack of an activity manager instance related to the application on the top of an activity record list.
